(19) United States
(12) Patent Application Publication
(10) Pub. No.: US 2017/0112162 A1
(43) Pub. Date: Apr. 27, 2017

(54) AN EDIBLE PRODUCT

(71) Applicant: Kraft Foods R & D, Inc., Deerfield, IL (US)

(72) Inventors: Thorsten Gustav, Deerfield, IL (US); Michael Schulz, Deerfield, IL (US)

(21) Appl. No.: 15/301,936

(22) PCT Filed: Apr. 30, 2015
(86) PCT No.: PCT/IB2015/053159

§ 371 Date: Oct. 4, 2016

(30) Foreign Application Priority Data
May 2, 2014 (GB) 1407766.3

(51) Int. Cl. A23G 1/00; A23G 1/20

(52) U.S. Cl. CPC A23G 1/005; A23G 1/0059; A23G 1/0076; A23G 1/203

(57) ABSTRACT

Disclosed is an edible product comprising an outer shell and a filling, wherein the outer shell is provided with a predefined area of weakness on an interior surface thereof. Also disclosed is a corresponding method and apparatus.

The present invention relates to an edible product and improvements in cold stamping techniques, used to produce edible shells formed from chocolate and other edible materials.

There are a number of prior art techniques which may be used to form hollow chocolate shells but a particularly preferred method is known as cold stamping. This involves immersing a refrigerated stamp or die into a corresponding mould containing molten chocolate. The chilled stamp causes the molten chocolate to solidify quickly into a well-defined shape. The technique lends itself well to automation and scaling and is widely used to produce shells, which may then be used in further processes which may, for instance, include filling the shell with a further substance to form a praline.

Improvements in mouth feel and consumer sensation are constantly sought and there is a desire to replicate an experience familiar to consumers of choc ices or chocolate covered ice-cream bars. In such products, a consumer is used to biting through the outer chocolate layer, into the ice cream within. The chocolate outer layer tends to fracture with a satisfying snap or crack, which adds to the consumer experience. Splinters of chocolate are produced, which can also add to the enjoyment of consuming the product.

It is not generally possible to recreate this auditory sensation with filled chocolate sweets, served at or around room temperature.

Embodiments of the present invention aim to improve the consumer experience of eating certain forms of filled chocolate sweets.

According to a first aspect of the present invention, there is provided an edible product comprising an outer shell and a filling, wherein the outer shell is provided with a predefined area of weakness on an interior surface thereof.

In one embodiment, the predefined area of weakness is a region of shell which is thinner than other surrounding regions.

In one embodiment, the predefined area of weakness is in the range 30% to 85% of the thickness of the surrounding regions.

In one embodiment, the predefined area of weakness is in the range 40% to 70% of the thickness of the surrounding regions.

In one embodiment, the predefined area of weakness is about 50% of the thickness of the surrounding regions.

In one embodiment, the predefined area of weakness is one or more of: a line; a zig-zag; a circle; a square; a triangle; and a geometric shape.

In one embodiment, the predefined area of weakness has a generally triangular profile in cross-section.

In one embodiment, the outer shell is formed from chocolate.

According to a second aspect of the present invention, there is provided a method of manufacturing an edible product comprising the steps of:
providing a mould comprising a quantity of molten edible material;
introducing a chilled stamp into the mould, to solidify the material and so form a shell, wherein the stamp comprises a projection arranged to produce a predefined area of weakness in the shell;
filling the shell with a relatively soft filling;
closing the shell to seal in the filling.

In one embodiment, the projection is arranged to penetrate the material to a depth of 30% to 85% of the thickness of the material immediately surrounding the predefined area of weakness.

In one embodiment, the projection is arranged to penetrate the material to a depth of 40% to 70% of the thickness of the material immediately surrounding the predefined area of weakness.

In one embodiment, the projection is arranged to penetrate the material to a depth of about 50% of the thickness of the material immediately surrounding the predefined area of weakness.

According to a third aspect of the present invention, there is provided a stamp for use with a complementary mould in a cold-stamping apparatus for producing edible shells, comprising at least one projection on a major surface thereof, arranged such that said projection creates an area of weakness in a shell produced using the stamp.

In one embodiment the projection tapers from a relatively wide portion adjacent to the major surface, to a relatively narrow portion.

In one embodiment, the projection is substantially triangular in cross-section.

In one embodiment, the stamp comprises a plurality of projections arranged to form a corresponding plurality of areas of weakness in the shell produced sing the stamp.

In one embodiment, the stamp is provided with a cooling system, such that its temperature can be controlled, relative to the mould.

In one embodiment, the cooling system is provided with a thermostatic control to maintain the stamp temperature at a desired level.

In one embodiment, the cooling system comprises at least one cooing element positioned internal to the stamp.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

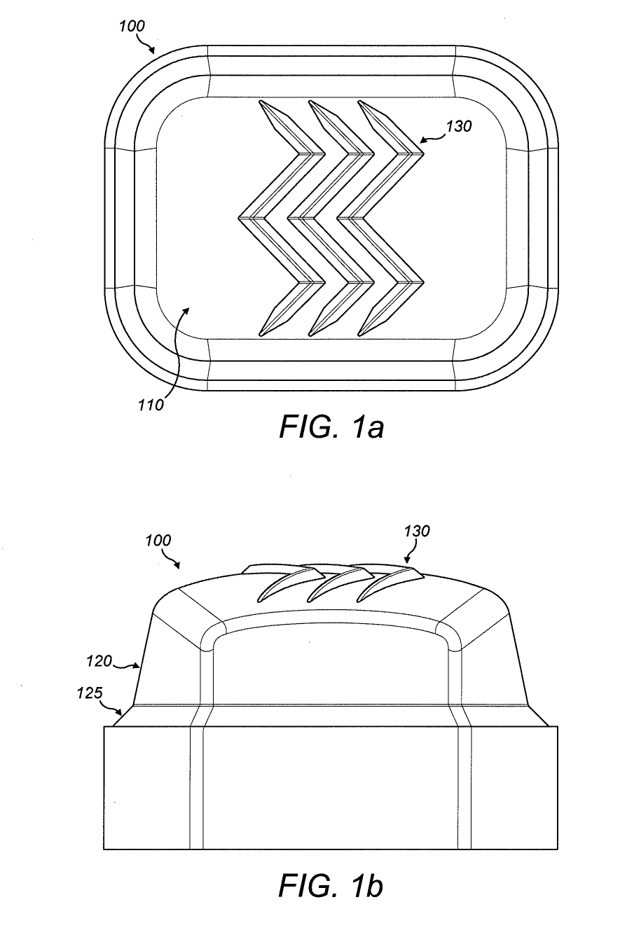

FIG. 1a shows a plan view of the surface of a stamp according to an embodiment of the present invention;

FIG. 1b shows a side view of the stamp of FIG. 1a;

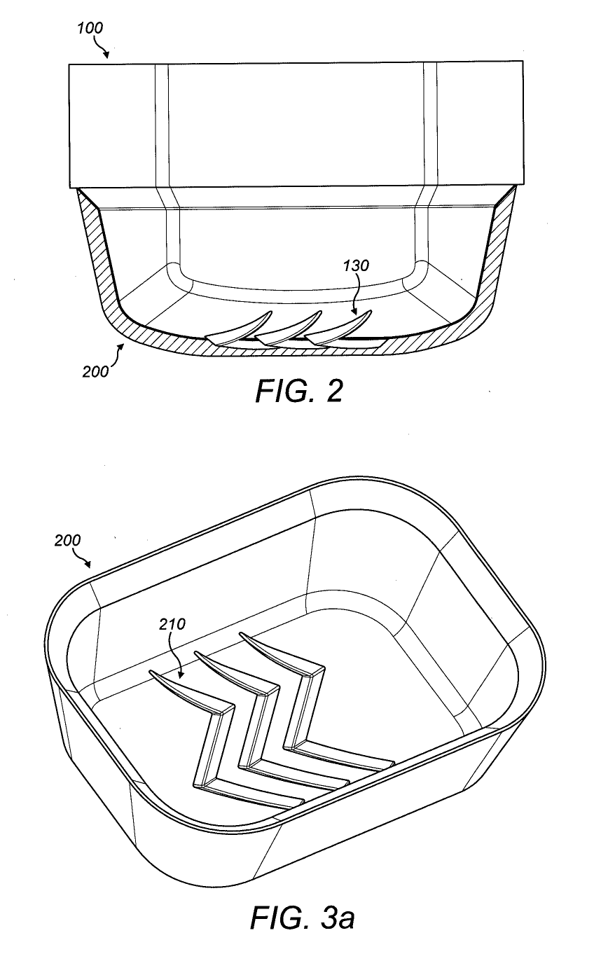

FIG. 2 shows a cross-sectional view of the stamp of FIG. 1a, when immersed in chocolate;

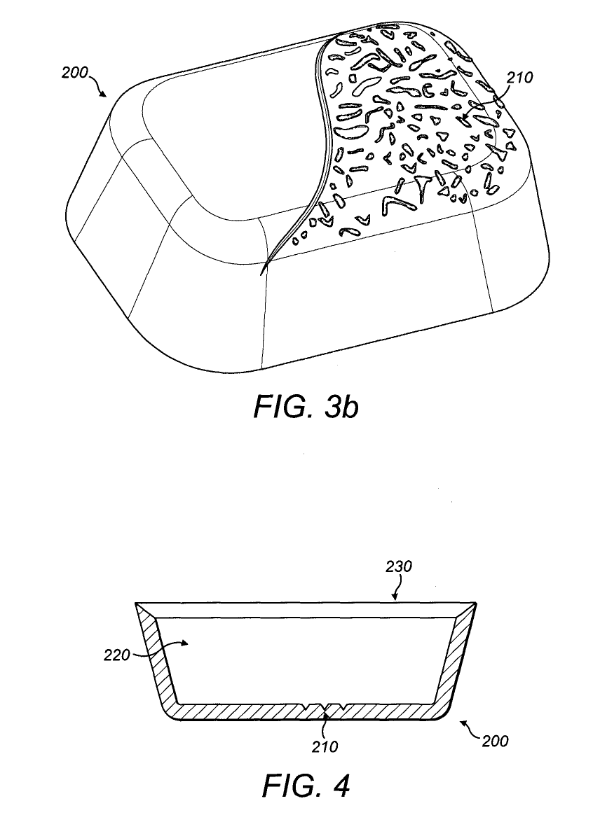

FIGS. 3a and 3b show internal and external view of the formed shells, according to an embodiment of the present invention;

FIG. 4 shows a cross-sectional view of the completed sweet, once filled and backed off;

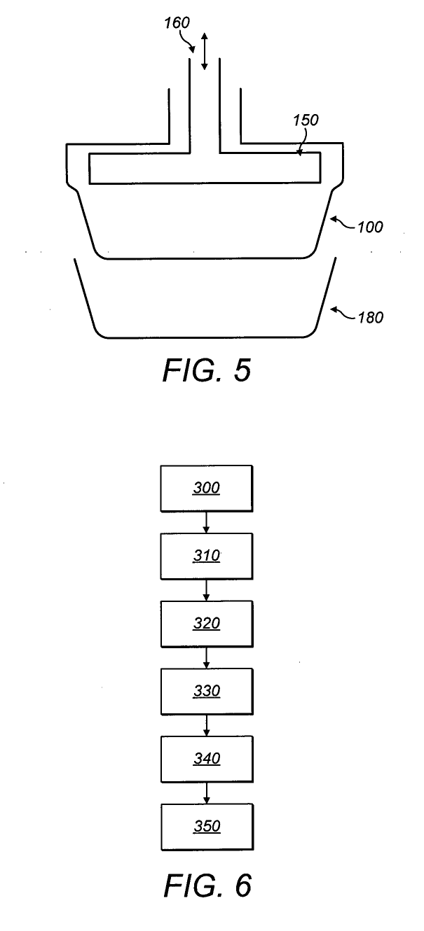

FIG. 5 shows a view of the stamp according to an embodiment of the present invention, attached to temperature-controlled stamping apparatus, and a mould; and

FIG. 6 shows a flow chart of the steps according to an embodiment of the present invention.

In prior art filled chocolate sweets, the outer chocolate shell breaks in an uncontrolled manner when bitten by the consumer. This is the case for sweets which are intended and sized to be eaten as a whole, as well as with bars which are intended and sized to have portions bitten from them.

It has been found that by controlling the manner in which an outer chocolate shell breaks, it is possible to enhance the eating experience for the consumer. In particular, it has been found that by providing predefined lines of weakness or break lines on an inner surface of the chocolate shell, the shell can be made to produce a snap or crack as it is bitten into. This replicates the experience enjoyed by consumers when eating a choc-ice type of product.

The pre-defined lines of weakness produce a crisper, more defined breaking of the shell, which is what, in turn, produces the audible click or snap and a corresponding sensation in the mouth of the consumer.

Furthermore, splinters of chocolate shell are produced as the shell breaks, the shapes of which are defined by the configuration of the break lines. This, again, can increase the enjoyment of the consumer, when eating the sweet or bar.

In prior art choc ice products, the chocolate coating is provided by dipping the frozen ice cream into molten chocolate, which produces a substantially uniform coating of chocolate on the product. However, manufacturing of filled chocolate sweets tends to require the creation of a shell into which the filling is inserted.

In order to produce sweets or bars having the desired characteristics, the chocolate shell is produced using known cold stamping techniques, which are then adapted by means of specially arranged stamps which are configured to produce one or more pre-defined areas or lines of weakness on an internal surface of the shell. It is preferred to have the line or lines of weakness on an internal surface, rather than an external surface, because the external design of the sweet or bar is unaffected. It is possible to have a variety of different lines of weakness or break patterns applied to different sweets in a packet, so that the consumer is unaware of which one has been applied to a given sweet. As a result, differently shaped splinters of chocolate may be produced from different sweets in a packet, all of which appear identical from the exterior.

The adaptation of the stamp requires one or more relatively raised portions which penetrate deeper into the molten chocolate in the mould and so produce correspondingly thinner shell sections in the vicinity of the raised portions. These thinner sections are the pre-defined areas of weakness which will tend to break in preference to the surrounding, thicker, sections of shell.

FIG. 1a shows a stamp 100 suitable for creating a chocolate shell according to an embodiment of the present invention. It comprises a gently sloping upper surface 110 and tapering sides 120. The overall shape of the perimeter is substantially rectangular, but any shape may be selected, provided that the shell so produced can be removed from the mould readily. The corresponding mould is not shown, but is dimensioned to closely correspond to the outer profile of the stamp 100, such that the thickness of the shell produced is dictated by the distance between the exterior surface of the stamp 100 and the interior surface of the mould.

The gently sloping upper surface 110 is provided, in this example, with a plurality of zig-zag protrusions 130. These can be best seen in FIGS. 1a and 1b. Each protrusion is peaked to extend from a generally wider base, tapering toward a relatively sharp point. The tapering is provided to facilitate easy removal from the mould once the cold stamping process has been completed. In cross-section, the protrusion 130 is generally triangular in shape, although other shapes are possible, provided they follow the normal rules for removal of stamps from moulded products. An example of another suitable shape would be semi-circular.

The three zig-zag shapes shown in FIG. 1a are exemplary only. The design of break lines chosen could consist of a variety of different forms, and could consist of one or a plurality of repeating or different patterns. In particular, the break lines or areas of weakness could comprise one or more straight lines, curved lines or shapes such as triangles, squares, circles or other closed or open geometric shapes. The shape or shapes chosen will affect the shape of chocolate splinter created when the sweet is broken open.

FIG. 2 shows a view of the stamp 100, when inserted in a mould (not shown). This shows the protrusions 130 penetrating more deeply into the chocolate shell, resulting in a relatively thinner region in the vicinity of the protrusions, than the surrounding region. The chocolate shell 200 is formed around the stamp 100, up to the rim area 125, which corresponds to the extent of insertion of the stamp into the mould.

The extent of penetration into the shell material can be controlled to give the desired properties to the predefined area of weakness. For instance, relatively deeper and shallower penetrations into the material of the shell can produce different effects and cause the shell material to break in different ways. It is found that, in general, a penetration depth in the range of 30 to 85% of the thickness of the material surrounding the area of penetration (the are of predefined weakness) is suitable in most cases. More suitably, a depth of penetration of 40 to 70% is found to be better, but in most circumstances, a penetration depth of 50% combines a crisp break or snap of the shell material while maintaining structural integrity of the shell.

For instance, in a chocolate shell which has a thickness of 4 mm in areas where there is no predefined area of weakness, then the projections 130 penetrate to a depth of 2 mm into the shell to create a predefined area of weakness. Alternatively, the projections could be dimensioned to penetrate 1.2 mm(30%) to 3.4 mm (85%), if a different structure is required.

FIG. 3a shows a perspective internal view of the shell, once removed from the mould. The break lines 210 are clearly visible as recesses on the internal surface of the shell 200. This is the only time when they are visible since, in later steps, they will be concealed by fillings as will be described.

FIG. 3b shows an external view of the shell 200, which clearly shows that the break lines are not visible to the consumer. However, the external view does show that some other surface decoration 220 is present. This is created by adapting the mould, rather than the stamp. It is not important to the present invention if such surface decoration is present or not, but it does demonstrate the flexibility possible with embodiments of the present invention.

Once the chocolate has solidified in the usual way, the stamp 100 can be removed from the mould, and the shell can be passed on to the next processing step. In a first embodiment of the invention, the shell 200 is arranged to be consumed in a single bite and is filled with a soft centre such as caramel, flavoured créme, mousse or the like. The filling is sealed in the shell by backing off with molten chocolate.

FIG. 4 shows a cross-section through an embodiment of the present invention, once the process described above is complete. The shell 200 is filled in a known way with a filling 220, and the filled shell is then backed off with a layer of chocolate or other material 230. The cross-section also shows the areas of weakness 210, but these will not be visible in the complete product, appearing only on the inside of the shell 200.

FIG. 5 shows a simplified view of the stamp 100, as used with cold stamping apparatus. Arranged internal to the stamp is a cooling element 150. This can take the form of a coiled pipe through which runs a chilled fluid. It could, alternatively, take the form of a Peltier cooler, for instance. In any event, the cooling element 150 is connected to and controlled by a cooling system 160, operable in a known way. FIG. 5 also shows the mould 180 into which the stamp 100 is inserted. In some embodiments, a plurality of moulds are provided in a mould tray, and a matching plurality of stamps are provided such that a plurality of shells are created simultaneously.

FIG. 6 shows a flowchart setting out the steps involved in the cold stamping process. It is important to note that the cold-stamping process itself is known from the prior art, and embodiments of the present invention change the nature and form of the stamp, and do not require a change in other features of the process.

Step 300 is the provision of a mould or, more likely, a plurality of moulds. At step 310, a metered dose of molten chocolate or other shell material is added to the mould 180. At step 320, the chilled stamp 100 is lowered into the mould and the molten chocolate therein is forced to occupy the gap formed between the outer surface of the stamp and the inner surface of the mould. At step 330, after a defined period of time, the shell has set and the stamp 100 is removed, leaving the shell 200 in the mould 180. The shell can either be removed at this point or it may remain in the mould tray for the following processes. At step 340, a filling is introduced into the shell, and at step 350, the filling is enclosed in the shell using a backing off process.

In the first embodiment, the consumer places the entire sweet in their mouth to consume it in one bite. As the sweet is bitten into or chewed, the shell will break with a pleasing snap and release one or more chocolate splinters, which will provide a pleasing experience to the consumer.

In a second embodiment, the shell is dimensioned to be bar sized, that is to say, it is not intended to be consumed in a single bite and, instead, the consumer will take several bites from it. The only substantive difference in this embodiment is the size of the shell, and hence the number of break lines provided, which can be spread along the length of the shell. The same audible snap effect is experienced, which may actually be more clearly discernible, since the entire product is not contained in the consumer's mouth at the time.

In a third embodiment, the shell is filled with a soft centre, particularly with a spreadable chocolate material, with the intention that the entire finished product, consisting of the filled chocolate shell is produced in a size suitable to cover a single piece of toast with spreadable chocolate. This third embodiment resembles the first embodiment and differs mostly in its intended purpose, as set out above.

In use, the consumer would place the chocolate product on a piece of toast and then break it open using a knife. The presence of the break lines 130 on the interior surface of the shell, allow the shell to break open easily to reveal the spreadable filling which can then be spread around the toast in the usual way. The spread will, of course also contain splinters of chocolate from the shell but since at least some of these are going to be produced in defined shapes, it tends to add to the consumer experience.

In the absence of break lines of this sort, it is likely that the act of trying to break open the shell would require more force and would result in the toast breaking apart before the shell. This would not offer a good consumer experience.

In all the embodiments described, the presence of the softer filling in the shell tends to provide a force against which breaking must be achieved i.e. the filling supports the shell to some extent. The provision of break lines on an interior surface of the shell allows the breaking of the shell to occur in a more controlled manner, which focuses the breaking forces in a way which allows the production of the audible snap or crack which has been referred to.

Embodiments of the present invention provide an improved consumer experience by providing an audible experience to accompany breaking into the product to reveal the centre. Furthermore the production of defined splinter shapes when the shell is broken open, further enhances the consumer experience. The break lines which are required to achieve these desirable aims are provided on an interior surface of the product shell, where they do not interfere with more general product design issues, concerning the overall aesthetic appeal of the product.

Throughout this specification, reference has been made to chocolate as the shell material, but the skilled person will appreciate that other materials which are able to be cold-stamped can also benefit from the techniques and processed disclosed herein.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An edible product comprising an outer shell and a filling, wherein the outer shell is provided with a predefined area of weakness on an interior surface thereof.

2. The edible product of claim 1 where in the predefined area of weakness is a region of shell which is thinner than other surrounding regions.

3. The edible product of claim 2 wherein the predefined area of weakness is in the range 30% to 85% of the thickness of the surrounding regions.

4. The edible product of claim 1 wherein the predefined area of weakness is one or more of: a line; a zig-zag; a circle; a square; a triangle; and a geometric shape.

5. The edible product of claim 2 wherein the predefined area of weakness has a generally triangular profile in cross-section.

6. The edible product of claim 1 wherein the outer shell is formed from chocolate.

7. A method of manufacturing an edible product comprising the steps of:
providing a mould comprising a quantity of molten edible material;
introducing a chilled stamp into the mould, to solidify the material and so form a shell,
wherein the stamp comprises a projection arranged to produce a predefined area of weakness in the shell;
filling the shell with a relatively soft filling; closing the shell to seal in the filling.

8. The method of claim 7 wherein the projection is arranged to penetrate the material to a depth in the range of 30% to 85% of a thickness of a surrounding area.

9. A stamp for use with a complementary mould in a cold-stamping apparatus for producing edible shells, comprising at least one projection on a major surface thereof, arranged such that said projection creates an area of weakness in a shell produced using the stamp.

10. A stamp as claimed in claim 9 wherein the projection tapers from a relatively wide portion adjacent to the major surface, to a relatively narrow portion.

11. The stamp as claimed in claim 10, wherein the projection is substantially triangular in cross-section.

12. The stamp as claimed in claim 9, comprising a plurality of projections arranged to form a corresponding plurality of areas of weakness in the shell produced sing the stamp.
